(19) United States
(12) Patent Application Publication
(10) Pub. No.: US 2017/0349235 A1
(43) Pub. Date: Dec. 7, 2017

(54) QUICK-RELEASE DEVICE OF BICYCLE

(71) Applicant: TOKEN PRODUCTS INC., Taichung City (TW)

(72) Inventor: Jens Buder, Chemnitz (DE)

(21) Appl. No.: 15/350,438

(22) Filed: Nov. 14, 2016

(30) Foreign Application Priority Data
Jun. 7, 2016 (TW) 105208571

(51) Int. Cl. B62K 25/02

(52) U.S. Cl. CPC B62K 25/02; B62K 2206/00

(57) ABSTRACT

A quick-release device of a bicycle is provided for being connected to a first fork arm and a second fork arm of a frame and includes a rod member, an abutting unit and a screwing unit. The rod member is for being disposed through the first and second fork arms. The abutting unit is arranged on one of two ends of the rod member and for optionally tightly abutting against the first fork arm. The screwing unit is arranged on the other of the two ends of the rod member for being adjustable positioned on the second fork arm and has a first threaded section, and a thread pitch of the first threaded section is at least greater than or equal to 2 mm.

### BACKGROUND OF THE INVENTION

### Field of the Invention

The present invention relates to a quick-release device for a bicycle.

### Description of the Prior Art

A common quick-release device as disclosed in TWM412120 at least includes a connecting axial tube and an abutting mechanism, one of two ends of the connecting axial tube has an exterior threaded section which can be screwed with a frame, the other end of the two ends of the connecting axial tube has the abutting mechanism, the abutting mechanism at least has an axial rod, a restricting block and a toggling handle, the axial rod is connected to the connecting axial tube and disposed through the restricting block, and the toggling handle is pivotable and abuts against the restricting block.

However, the above-mentioned quick-release device needs to be screwed to a fork arm, so it takes more time to assemble the quick-release device. In addition, if the quick-release device is disassembled for too many times, the exterior threaded section can be easily abraded and needs to be replaced. Therefore, how to prevent the exterior threaded section from being abraded and save a usage cost are the goals that the industry needs to work toward.

The present invention has arisen to mitigate and/or obviate the afore-described disadvantages.

### SUMMARY OF THE INVENTION

The major object of the present invention is to provide a quick-release device of a bicycle which can save a time of the quick-release device being assembled on a frame, effectively prolong a service life and reduce a usage cost.

To achieve the above and other objects, a quick-release device of a bicycle is provided for being connected to a first fork arm and a second fork arm of a frame and includes a rod member, an abutting unit and a screwing unit. The rod member is for being disposed through the first and second fork arms. The abutting unit is arranged on one of two ends of the rod member and for optionally tightly abutting against the first fork arm. The screwing unit is arranged on the other of the two ends of the rod member for being adjustably positioned on the second fork arm and has a first threaded section, and a thread pitch of the first threaded section is at least greater than or equal to 2 mm.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a breakdown view of FIG. 1;

FIGS. 3 and 4 are drawings showing an assembling operation;

FIG. 5 is a partially-enlarged view of FIG. 3;

FIG. 6 is a partially-enlarged view of FIG. 5;

FIG. 7 is an assembly drawing of a second preferred embodiment of the present invention; and

FIG. 8 is an assembly drawing of a third preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

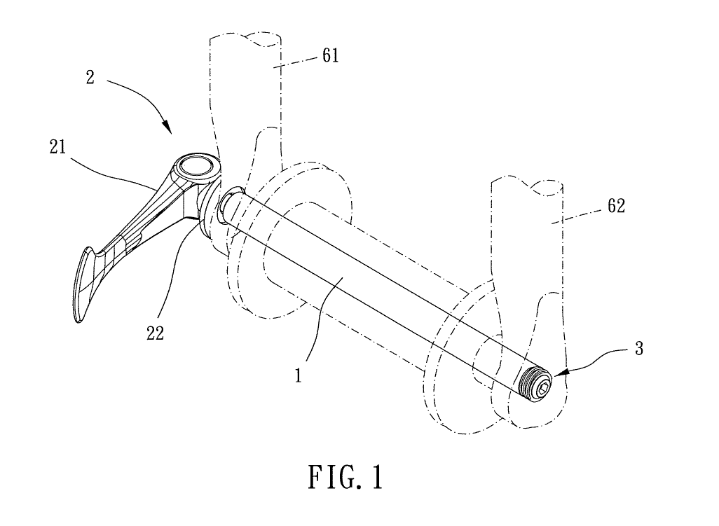

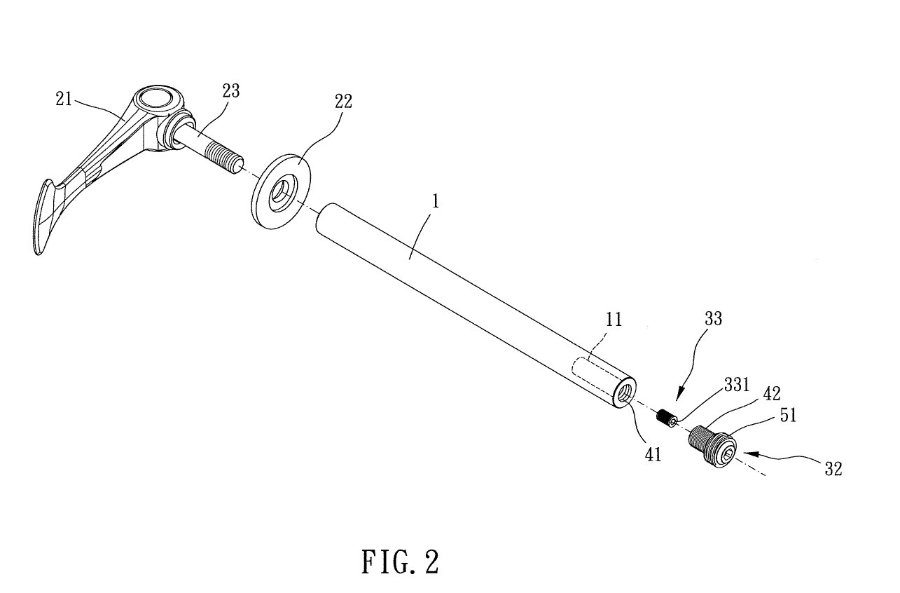

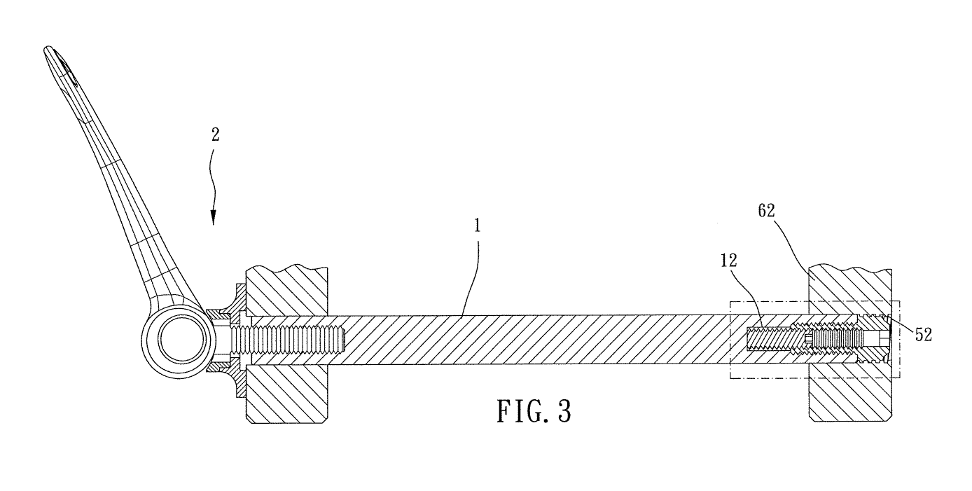

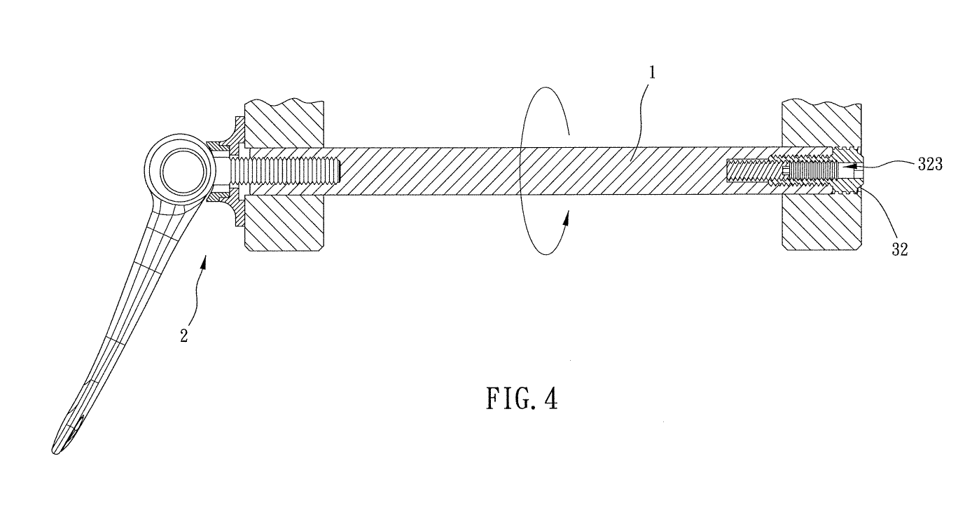

Please refer FIGS. 1 to 6 for a first preferred embodiment of the present invention. A quick-release device of a bicycle is provided for being connected to a first fork arm 61 and a second fork arm 62 of a frame, and the quick-release device of the bicycle includes a rod member 1, an abutting unit 2 and a screwing unit 3.

The rod member 1 is for being disposed through the first and second fork arms 61, 62. The abutting unit 3 is arranged on one of two ends of the rod member 1 and for optionally tightly abutting against the first fork arm 61. The screwing unit 3 is arranged on the other of the two ends of the rod member 1 for being adjustably positioned on the second fork arm 62 and has a first threaded section 51, and a thread pitch P of the first threaded section 51 is at least greater than or equal to 2 mm.

In the first embodiment, the first threaded section 51 is for being engaged with the second fork arm 62, and the second fork arm 62 has a second threaded section 52 which is engaged with the first threaded section 51. In addition, the thread pitch P of the first threaded section 51 is 3 mm for assembling convenience. It is understandable that the first threaded section can be manufactured through different processing ways, for example but not limited to, turnery manufacturing, powder metallurgy or metal injection. Preferably, a number of loops of a thread of the first threaded section 51 is between 1 to 3 for different assembling requirements and engaging strength. In the first embodiment, the number of the loop of the thread of the first threaded section 51 is 2.5 so that the quick-release device and the frame can be preferably engaged.

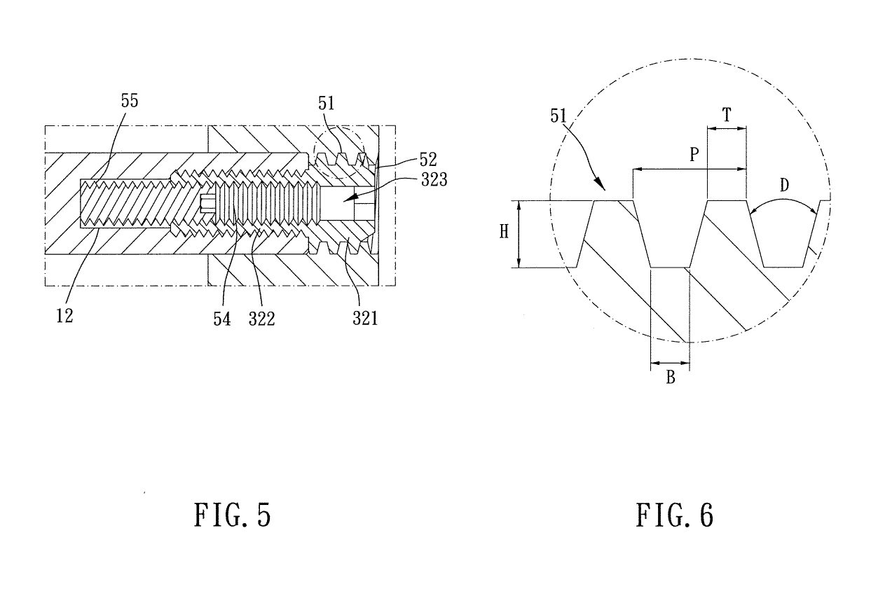

Preferably, the first threaded section 51 includes a thread having a trapezoid cross-section so that the thread has a stronger structural strength and is more abrasion-resistant. In addition, the threaded section includes the thread having the trapezoid cross-section so that the rod member 1 contacts the two fork aims 62 in more area to elevate the engaging strength and to prevent the rod member 1 and the two fork arms 62 from loosing off from each other. A greater contact area can prevent stress concentration to keep a structural integrity of the first threaded section 51. In other words, the threaded section including the thread having the trapezoid cross-section provides a preferable engaging effect and a longer service life, and when the thread of the first threaded section 51 is abraded, a user can adjust a corresponding nut to continue to use the first threaded section 51. In the first embodiment (as shown in FIG. 6), a crest width T of the first threaded section 51 is substantially 1.098 mm, a root width B of the first threaded section 51 is substantially 0.968 mm, a thread height H of the first threaded section 51 is substantially 1.75 mm, and a thread angle D of the first threaded section 51 is substantially 30 degrees.

When the screwing unit 3 is engaged with and positioned on the second form arm 62, the user can operate the abutting unit 2 to tightly connect the screwing unit 3 to the frame. The abutting unit 2 includes an operating handle 21, a blocking member 22 and a link-up rod 23, the link-up rod 23 is disposed through the blocking member 22 and connected with the rod member 1, the operating handle 21 is pivotably connected to the link-up rod 23, the operating handle 21 and the blocking member 22 are arranged on an outer side of the first fork arm 61, and the operating handle 21 is operable to press the blocking member 22 so as to urge the blocking member 22 to abut against the first fork arm 61.

Furthermore, the screwing unit 3 further has an engaging member 32, and a surface of the engaging member 32 has the first threaded section 51 and is releasably assembled on the other of the two ends of the rod member 1. When the first threaded section 51 is abraded and unusable, the user only needs to replace the engaging member 32. In addition, it is convenient and economic that the user can change the engaging member 32 according to a dimension of the second form arm. In the first embodiment, the engaging member 32 has a radially-enlarged section 321 and a radially-reduced section 322, the first threaded section 51 is arranged on the radially-enlarged section 321, and the radially-reduced section 322 has an exterior threaded section 42. Specifically, the other end of the two ends of the rod member 1 has a through hole 11 and an interior threaded section 41 which is on an inner wall of the through hole 11, the radially-reduced section 322 is inserted into the through hole 11, the exterior threaded section 42 is engaged with the interior threaded section 41, and the radially-enlarged section 321 abuts against the rod member 1.

Specifically, the quick device of the bicycle further includes a bolt member 33, the bolt member 33 is adjustably disposed between the rod member 1 and the engaging member 33, and the bolt member 33 is configured to abut against the engaging member so as to make sure that the engaging member will rotate due to unexpected force; that is, the engaging member 32 can be fixedly positioned.

Preferably, when the bolt member 33 abuts against the engaging member 32, the bolt member 33 also abuts the rod member 1 toward the abutting unit 2 so that the rod member 1, the bolt member 33 and the engaging member 32 can be in a balance and restricted and positioned by each other. In the first embodiment, the bolt member 33 is arranged in the rod member 1, specifically, the engaging member 32 further has a communicating portion 323 for a tool (for example, a hexagonal wrench) to be disposed therethrough, the rod member 1 further has an abutting engaging member 12 which communicates with the communicating portion 323, and the bolt member 33 is partly connected to the engaging member 32 and abuttable against the abutting engaging portion 12. An inner wall of the abutting engaging portion 12 is plane, and the abutting engaging portion 12 is greater than the communicating portion 323 in radial dimension. It is understandable that the bolt member 33 has a connecting hole 331 for being assembled to the tool, and the user can stretch the tool into the communicating portion 323 to be engaged with the connecting hole 331 and further to adjust a position of the bolt member 33.

Specifically, in the first embodiment, the bolt member 33 is screwed with the engaging member 32 so that the position of the bolt member 33 can be continuously and slightly adjusted. More specifically, a fourth threaded section 54 is arranged on an inner wall of the engaging member 32, a surface of the bolt member 33 has a fifth threaded section 55 which is engaged with the fourth threaded section 54, the abutting engaging portion 12 is greater than the bolt member 33 in radial dimension, and the bolt member 33 is adjustably and positionably disposed through the communicating portion 323 and an interior of the abutting engaging portion 12.

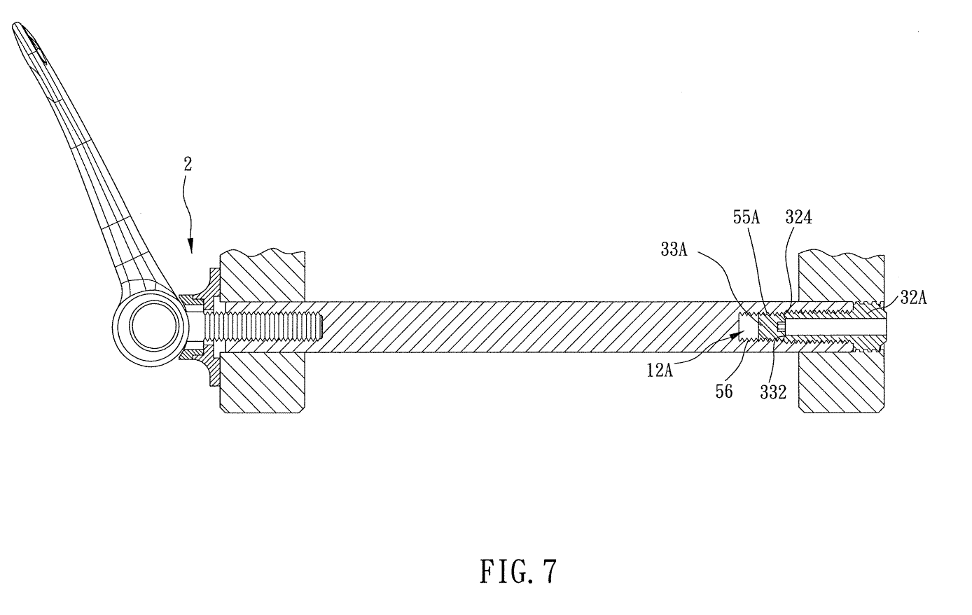

Of course, a dimension and a mode of the abutting engaging portion 12 is not limited as above-mentioned description. Please refer to a second embodiment of FIG. 7, specifically, the inner wall of an abutting engaging portion 12A has a sixth threaded section 56 circumferentially, a surface of a bolt member 33A has a fifth threaded section 55A circumferentially which is engaged with the sixth threaded section 56, and the bolt member 33A is adjustably and positionably disposed through the an interior of the abutting engaging portion 12A. More specifically, the bolt member 33A has a first abutting face 332, the engaging member 32A has a second abutting face 324, and the bolt member 33A is operable to urge the first abutting face 332 to tightly abut against the second abutting face 324.

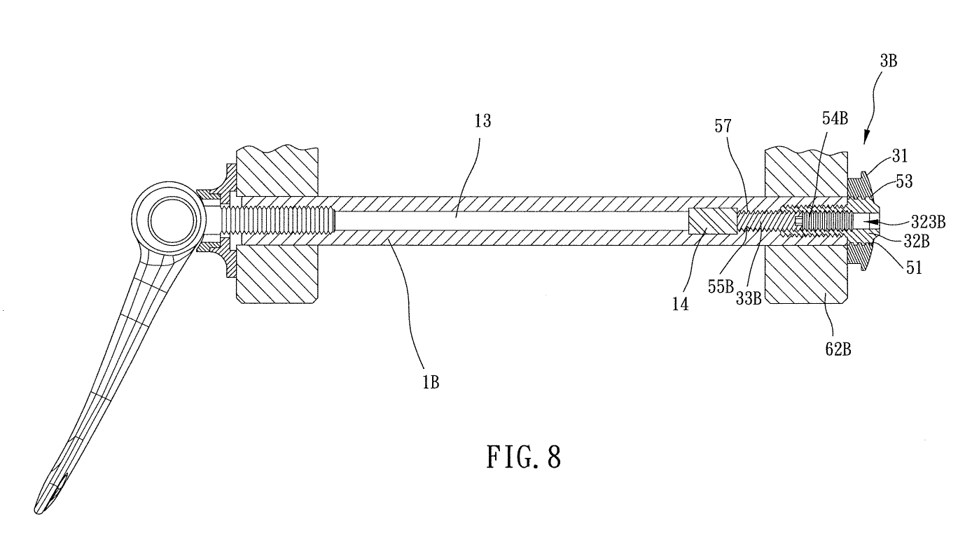

In addition, the quick-release device of the bicycle may be in other modes. Please refer to a third embodiment of FIG. 8. A screwing unit 3B further ha an abutting member 31, the abutting member 31 has a third threaded section 53 which is engaged with the first threaded section 51, the first threaded section 51 is disposed through and projects out of a second form arm 62B and screwed with the abutting member 31, and the abutting member 31 is for abutting against the second fork aim 62B for being configured on the second fork arm in different dimensions.

In addition, a rod member 1B further has a tube 13 which communicates with a communicating portion 323B and a stopping member 14, the tube 13 is equal to the communicating portion 323B in radial dimension, a fourth threaded section 54B is arranged on an inner wall of the engaging member 32B, a seventh threaded section 57 is arranged in the tube 13 and continuously connected to the fourth threaded section 54B, the stopping member 14 is fixedly disposed in the tube 13 and neighboring to the seventh threaded section 57, a surface of the bolt member 33B has a fifth threaded section 55B circumferentially which is engaged with the fourth and seventh threaded sections 54B, 57, and the bolt member 33B is adjustably and positionably projects through the communicating portion 323B and into the tube 13 to abut against the stopping member 14.

The quick-release device of the bicycle can be quickly assembled to the first and second fork arms, and the threaded section including the thread having the trapezoid cross-section provides the stronger structural strength to ensure a preferable service life. In addition, when the thread of the threaded section including the thread having the trapezoid cross-section is abraded, the user can use the corresponding nut to adjust a fitness of the threaded section and the nut so that the threaded section can continue to be used. The threaded section including the thread having the trapezoid cross-section is arranged on the engaging member, and when the threaded section including the thread having the trapezoid cross-section is unusable or used on the form arm in different dimensions, the user only needs to replace the engaging member.

While we have shown and described various embodiments in accordance with the present invention, it should be clear to those skilled in the art that further embodiments may be made without departing from the scope of the present invention.

What is claimed is:

1. A quick-release device of a bicycle, for being connected to a first fork aim and a second fork arm of a frame, including:
a rod member, for being disposed through the first and second fork arms;
an abutting unit, arranged on one of two ends of the rod member, for optionally tightly abutting against the first fork arm;
a screwing unit, arranged on the other of the two ends of the rod member for being adjustably positioned on the second fork arm, having a first threaded section, a thread pitch of the first threaded section being at least greater than or equal to 2 mm.

2. The quick-release device of the bicycle of claim 1, wherein the first threaded section includes a thread having a trapezoid cross-section.

3. The quick-release device of the bicycle of claim 1, wherein a number of loops of a thread of the first threaded section is between 1 to 3.

4. The quick-release device of the bicycle of claim 1, wherein the first threaded section is for being engaged with the second fork arm, and the second fork arm has a second threaded section which is engaged with the first threaded section.

5. The quick-release device of the bicycle of claim 1, wherein the screwing unit further has an abutting member, the abutting member has a third threaded section which is engaged with the first threaded section, the first threaded section is disposed through and protrudes out of the second fork arm and screwed with the abutting member, and the abutting member is for abutting against the second fork arm.

6. The quick-release device of the bicycle of claim 1, wherein the abutting unit includes an operating handle, a blocking member and a link-up rod, the link-up rod is disposed through the blocking member and connected with the rod member, the operating handle is pivotably connected to the link-up rod, the operating handle and the blocking member are arranged on an outer side of the first fork arm, and the operating handle is operable to press the blocking member so as to urge the blocking member to abut against the first fork arm.

7. The quick-release device of the bicycle of claim 1, further including a bolt member, the screwing unit further having an engaging member, a surface of the engaging member having the first threaded section and being releasably assembled on the other of the two ends of the rod member, the bolt member adjustably disposed between the rod member and the engaging member, the bolt member configured to abut against the engaging member.

8. The quick-release device of the bicycle of claim 7, wherein the bolt member abuts against the engaging member and urges the rod member toward the abutting unit.

9. The quick-release device of the bicycle of claim 8, wherein the first threaded section includes a thread having a trapezoid cross-section and a thread pitch of the first threaded section is 3 mm, a crest width of the first threaded section is substantially 1.098 mm, a root width of the first threaded section is substantially 0.968 mm, a thread height of the first threaded section is substantially 1.75 mm, and a thread angle of the first threaded section is substantially 30 degrees; a number of loops of a thread of the first threaded section is 3; the first threaded section is for being engaged with the second fork arm, and the second fork arm has a second threaded section which is engaged with the first threaded section; the abutting unit includes an operating handle, a blocking member and a link-up rod, the link-up rod is disposed through the blocking member and connected with the rod member, the operating handle is pivotably connected to the link-up rod, the operating handle and the blocking member are arranged on an outer side of the first fork arm, and the operating handle is operable to press the blocking member so as to urge the blocking member to abut against the first fork arm; the engaging member has a radially-enlarged section and a radially-reduced section, the first threaded section is arranged on the radially-enlarged section, the radially-reduced section has an exterior threaded section, the other end of the two ends of the rod member has a through hole and an interior threaded section which is on an inner wall of the through hole, the radially-reduced section is inserted into the through hole, the exterior threaded section is engaged with the interior threaded section, and the radially-enlarged section abuts against the rod member; the bolt member is arranged in the rod member, the engaging member further has a communicating portion for a tool to be disposed therethrough, the rod member further has an abutting engaging member which communicates with the communicating portion, the bolt member is partly connected to the engaging member and abuttable against the abutting engaging portion, an inner wall of the abutting engaging portion is plane, the abutting engaging portion is greater than the communicating portion in radial dimension, and the bolt member has a connecting hole for being assembled to the tool.

10. The quick-release device of the bicycle of claim 9, wherein a fourth threaded section is arranged on an inner wall of the engaging member, a surface of the bolt member has a fifth threaded section which is engaged with the fourth threaded section, the abutting engaging portion is greater than the bolt member in radial dimension, and the bolt member is adjustably and positionably disposed through the communicating portion and an interior of the abutting engaging portion.

11. The quick-release device of the bicycle of claim 9, wherein the inner wall of the abutting engaging portion has a sixth threaded section circumferentially, a surface of the bolt member has a fifth threaded section circumferentially which is engaged with the sixth threaded section, the bolt member is adjustably and positionably disposed through the an interior of the abutting engaging portion, the bolt member has a first abutting face, the engaging member has a second abutting face, and the bolt member is operable to urge the first abutting face to tightly abut against the second abutting face.

12. The quick-release device of the bicycle of claim 8, wherein the first threaded section includes a thread having a trapezoid cross-section; a number of loops of a thread of the first threaded section is 3; the abutting unit includes an operating handle, a blocking member and a link-up rod, the link-up rod is disposed through the blocking member and connected with the rod member, the operating handle is pivotably connected to the link-up rod, the operating handle and the blocking member are arranged on an outer side of the first fork arm, and the operating handle is operable to press the blocking member so as to urge the blocking member to abut against the first fork arm; the screwing unit further has an abutting member, the abutting member has a third threaded section which is engaged with the first threaded section, the first threaded section is disposed through and protrudes out of the second fork arm and screwed with the abutting member, and the abutting member is for abutting against the second fork aim; the engaging member has a radially-enlarged section and a radially-reduced section, the first threaded section is arranged on the radially-enlarged section, the radially-reduced section has an exterior threaded section, the other end of the two ends of the rod member has a through hole and an interior threaded section which is on an inner wall of the through hole, the radially-reduced section is inserted into the through hole, the exterior threaded section is engaged with the interior threaded section, and the radially-enlarged section abuts against the rod member; the bolt member in arranged in the rod member, the engaging member further has a communicating portion for a tool to be disposed therethrough, the rod member further has a tube which communicates with the communicating portion and a stopping member, the tube is equal to the communicating portion in radial dimension, a fourth threaded section is arranged on an inner wall of the engaging member, a seventh threaded section is arranged in the tube and continuously connected to the fourth threaded section, the stopping member is fixedly disposed in the tube and neighboring to the seventh threaded section, a surface of the bolt member has a fifth threaded section circumferentially which is engaged with the fourth and seventh threaded sections, the bolt member is adjustably and positionably projects through the communicating portion and into the tube to abut against the stopping member, and the bolt member has a connecting hole for being assembled to the tool.
